(19) United States
(12) Patent Application Publication
(10) Pub. No.: US 2003/0224110 A1
(43) Pub. Date: Dec. 4, 2003

(54) Process for producing a conductive polymer cathode coating on aluminum capacitor anode bodies with minimal anodic oxide dielectric degradation

(75) Inventors: Philip Michael Lessner, Simpsonville, SC (US); Peter James Fernstrom, Easley, SC (US); Albert Kennedy Harrington, Fountain Inn, SC (US); Brian John Melody, Greer, SC (US); John Tony Kinard, Greer, SC (US)

Correspondence Address: BANNER & WITCOFF, 1001 G STREET N W, SUITE 1100, WASHINGTON, DC, 20001, US

(73) Assignee: KEMET ELECTRONICS CORPORATION, Greenville, SC (US)

(21) Appl. No.: 10/158,877

(22) Filed: Jun. 3, 2002

(51) Int. Cl. B05D 3/10; B05D 1/18; C08F 26/06

(52) U.S. Cl. 427/299; 427/430.1; 526/258

(57) ABSTRACT

An oxidizer solution for preparing conductive polymers, the solution comprising: at least one oxidizing agent; at least one buffering agent; and at least one solvent; wherein the pH of the oxidizer solution is about 2 or greater. A process of preparing a conductive polymer layer on an anodized surface of an aluminum substrate comprising i) dipping the substrate in an oxidizer solution, ii) drying, and iii) dipping the substrate in a monomer solution and polymerizing; wherein the oxidizer solution comprises at least one oxidizing agent; at least one buffering agent; and at least one solvent, wherein the pH of the oxidizer solution is about 2 or greater. Additional buffering agent is added to the oxidizer solution during the process of preparing the conductive polymer to maintain the pH at 2 or greater.

### FIELD OF THE INVENTION

The invention relates to buffered oxidizer solutions for producing conductive polymer cathode material coatings on anodized aluminum anode bodies via alternate dips in oxidizer and monomer solutions.

### BACKGROUND OF THE INVENTION

Aluminum Electrolytic Capacitors have played a role in shaping the electronic industry since the early 1900's. In comparison to other valve metals, aluminum is inexpensive, can be anodized to high voltages, and may be etched to produce high capacitance per unit volume. Wet capacitors are constructed by winding an anodized aluminum anode and a cathode prepared with low chloride papers, aluminum foil, and a liquid electrolyte. The wet electrolyte and the wound construction make this device undesirable for most surface mount applications due to its high Equivalent Series Resistance (ESR). In addition, wet capacitors are unable to withstand conditions associated with reflow soldering. In recent years, a stacked aluminum anode design utilizing one or more conductive polymers as the cathode has gained popularity for low ESR applications in the surface mount industry.

Conductive polymers such a polyanilines, polythiophenes and polypyrroles have been successfully used on tantalum porous anodes to produce a lower resistance solid-state device. In chemical oxidation polymerization, the oxidizing agents can be a cation (Fe III) or anion (persulfate). The more widely used dopants are anions of strong acids such as perchlorates and sulfonates.

Conductive polymer techniques derived from tantalum are now being applied to aluminum devices. To date, this has been done without considering the reduction in pH due to the oxidation process. The pH of oxidizing agent/dopant solution typically reaches 1 or less over the course of the polymerization reaction. It is believed that this is due to the division of persulfate molecules to form twice as many acid sulfate molecules.

Oxidizer solutions having a pH of approximately 1 readily attack an anodic oxide dielectric, dissolving the phosphate coating applied by the foil manufacturer as a hydration barrier. This attack also reduces the effective anodizing (withstanding) voltage of the anodic oxide.

### BRIEF SUMMARY OF THE INVENTION

The invention is directed to an oxidizer solution for preparing conductive polymers, the solution comprising: at least one oxidizing agent; at least one buffering agent; and at least one solvent; wherein the pH of the oxidizer solution is about 2 or greater. Preferably the oxidizer solution contains about 1 to about 40 wt % of the at least one oxidizing agent and a sufficient amount of the least one buffering agent to maintain the pH of the oxidizer solution greater than 2, preferably between about 2 and about 6. Other components may also be added, such as dopants and wetting agents, in amounts effective for their function. The remainder of the solution is at least one solvent.

In a preferred embodiment, the pH is from about 2 to about 3. In a further preferred embodiment, the oxidizing agent is ammonium persulfate and the buffer is ammonium hydroxide.

The invention is also directed to a process of preparing a conductive polymer layer on an anodized surface of an aluminum substrate comprising i) dipping the substrate in an oxidizer solution, ii) drying, and iii) dipping the substrate in a monomer solution and polymerizing; wherein the oxidizer solution comprises at least one oxidizing agent; at least one buffering agent; and at least one solvent; wherein the pH of the oxidizer solution is from about 2 or greater and wherein additional buffering agent is added to the oxidizer solution at least once during the process of preparing the conductive polymer to maintain the pH at 2 or greater, preferably between about 2 and about 6. Other components may also be added, such as dopants and wetting agents, in amounts effective for their function. The remainder of the solution is at least one solvent.

In a preferred embodiment, additional buffering agent is added to the oxidizer solution during the process of preparing the conductive polymer. Preferably, the buffering agent is added to the oxidizer solution at least twice, more preferably 2 to 25 times, during the process of preparing the conductive polymer to maintain the pH at 2 or greater.

### BRIEF DESCRIPTION OF THE DRAWINGS

FIG. 1 shows a hydration plot of current vs. time.

### DETAILED DESCRIPTION OF THE INVENTION

Conductive polymer cathode material coatings are applied onto anodized aluminum anode bodies via alternate dips in oxidizer and monomer solutions. However, when conventional oxidizer solutions are used, oxidizer molecules cleave into acidic species generating acid, which reduces the pH in the oxidizer solution. When dipped into the monomer solution, an acidic by-product is formed during the polymerization. This by-product attacks the outer layer of the anodic oxide dielectric resulting in reducing the effective anodizing voltage of the foil. This renders the foil subject to hydration by water present in the environment due to impairment of the hydration resistant layer of phosphate, etc., placed on the surface of the anodic oxide by the capacitor foil manufacturer.

It was discovered that the periodic addition of a buffering agent compensates for the pH reduction. Controlling the pH in the polymerization solution prevents excessively low pH. This protects the anodic oxide dielectric from degradation by the free acid produced as a by-product of the polymerization reaction. Thus, the invention is directed to an oxidizer solution containing cationic or anionic oxidizing agents, but buffered to maintain a pH at 2 or greater. This prevents attack of the anodic oxide dielectric during the polymerization process.

The oxidizer solution comprises at least one oxidizing agent, at least one buffering agent, and at least one solvent. The buffering agent is added to the oxidizer solutions to achieve a pH from about 2 or greater, preferably about 2 to about 6, more preferably about 2 to about 3.

The oxidizer solution contains about 1 to about 40 wt %, preferably about 25 to about 35 wt %, of the at least one oxidizing agent. The oxidizing agents can be a cationic such as Fe III perchlorates or anionic such as persulfate. Fe(III) oxidizing agents for preparing conductive polymers are also well known in the art. Jonas et al. (U.S. Pat. No. 4,910,645, which is hereby incorporated by reference in its entirety) teach various oxidizing agents for the polymerization of thiophenes and pyrroles, which oxidants include Fe(III) salts of organic and inorganic acids, alkali metal persulfates, ammonium persulfates, and others. Preferably the oxidizing agent is the anionic, in particular, ammonium persulfate since it is often difficult to remove cationic oxidizer residues.

The solvent makes up the balance of the oxidizer solution. Suitable solvents include water and alcohols. Preferably the solvent is water. Other components may be included such as dopants and wetting agents such as low molecular weight alcohols or standard surfactants.

At the start of the process, the oxidizer solution contains sufficient buffering agent to render the pH of the oxidizer solution to be 2 or greater.

Preferably additional buffering agent is added during the process of forming the conductive polymer, as necessary, to maintain the pH at 2 or greater. Preferably and conveniently, the buffering agent is added in even amount and time increments. Preferably, the buffering agent is added about 2 to about 25 times during the process, more preferably about 3 to about 20 times, even more preferably about 5 to about 15 times.

Any suitable buffering agent may be used. Preferably the buffering agent is ammonium hydroxide. Ammonia gas may also be utilized as well as low molecular weight amines, such as triethylamine, and low molecular weight alkanolamines, such as diethylethanolamine or dimethylethanolamine. (Low molecular weight means generally 12 carbons or fewer, typically 9 carbons or fewer.)

Suitable monomers include aniline, pyrrole, thiophene, and derivatives of these monomers. A derivative of thiophene, 3,4-ethylenedioxythiophene is particularly preferred because the polymer produced, poly(3,4-ethylenedioxythiophene) has a high stability in hot and humid environments. Monomers for preparing conductive polymers are well known in the art, for example as taught by U.S. Pat. No. 4,910,645 to Jonas et al., recited above.

The monomer is dissolved in as solvent. The solvent may be any suitable solvent in which the monomer is soluble, including, but not limited to, esters such as butyl acetate, ketones, aldehydes, ethers, and aromatic and non-aromatic hydrocarbons such as turpentine. The solvent used depends on which oxidizer is used since the oxidizer should not be soluble in the solvent.

The monomer typically contains a monomer, a solvent, and a dopant. Typically the dopant is in a salt form to prevent corrosion.

Repeated dips in the oxidizer solution may be made to reduce the number of monomer dip cycles required and to provide improved polymer coverage of external surfaces of a porous substrate. Typically, the process of dipping the substrate in the oxidizer solution and drying may be repeated 1 to 5 times, preferably 1 to 3 times, prior to dipping in the monomer solution.

The substrate is next dipped in a dilute monomer solution. Polymerization is allowed to occur at temperatures from about 0 to about 150° C., preferably from about 15 to about 40° C.

After dipping the substrate in a monomer solution and polymerizing, the substrate may be washed in an aqueous solution.

After the polymerization process, the aluminum anode coupons are reanodized to heal defects in the dielectric surface, and typically externally coated with layers of carbon and silver paint prior to electrical testing of the capacitor.

### EXAMPLE 1

Without buffering, persulfate oxidizer solution with an initial pH in the range of 2 to 3 will be reduced to a final pH in the range of about 1.0 to 1.25 at the end of the polymerization process. Table 1 demonstrates that periodic additions of 1.5 weight percent of ammonium hydroxide can be used to control the pH of 3.8 liters of an oxidizer solution containing 32% of ammonium persulfate by weight.

TABLE 1

| Pro- | | | |
|---|---|---|---|
| cess | Oxidizer Solution | Oxidizer Solution with | Ammonium Hydroxide |
| Cycle | w/o Buffer (pH) | Buffer (pH) | Additions (ml) |
| 1 | 2.38 | 2.33 | 0 |
| 2 | | 2.32 | 0 |
| 3 | | 2.47 | 30 |
| 4 | | 2.36 | 20 |
| 5 | | 2.46 | 30 |
| 6 | | 2.33 | 25 |
| 7 | | 2.36 | 30 |
| 8 | | 2.44 | 30 |
| 9 | | 2.46 | 30 |
| 10 | | 2.48 | 30 |
| 11 | 1.15 | 2.39 | 40 |

### EXAMPLE 2

Commercially available aluminum anode foil obtained from a capacitor foil manufacturer was cut into coupons, welded onto carrier bars and the edges anodized in aqueous solutions of ammonium citrate and ammonium phosphate. A baseline phosphate analysis was done by dissolving the coupons with strong acids, and using Inductively Coupled Plasma (ICP) and matrix matching to determine the amount of phosphate present in the aluminum dielectric. The baseline value was determined to be 0.45% by weight. The coupons were then divided into two test groups.

Coupons from Test Group A were soaked for one hour in a persulfate oxidizer solution with a pH of 2.5. Coupons from Test Group B were soaked for one hour in a persulfate oxidizer solution with a pH of 1.0. Test Groups, A and B, were analyzed for remaining phosphate content and reported as a percentage of the baseline value. Table 2 demonstrates that Test Group B lost more of its phosphate content due to the lower pH associated with a persulfate oxidizer solution.

TABLE 2

| Test Group | Phosphate (% of baseline) |
|---|---|
| A (pH = 2.5) | 48.9 |
| B (pH = 1.0) | 21.1 |

### Example 3

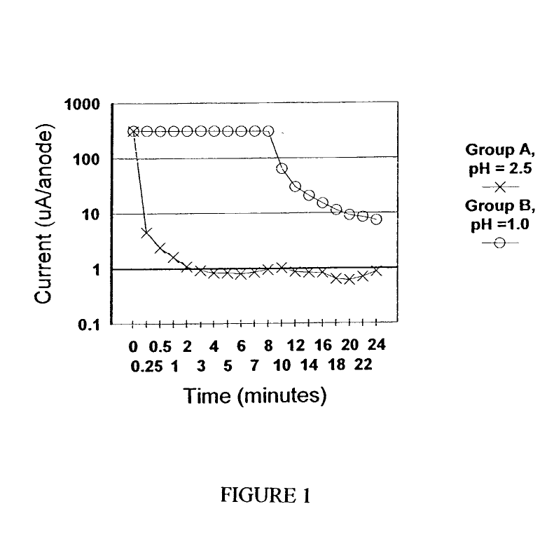

Test Groups, A and B, of Example 2 were exposed to a 90 minute water soak at 70° C. The samples were then anodized to 13 volts at a constant current of 1.5 microamps per anode in an aqueous solution of ammonium adipate at 50° C. for 24 minutes. From the plot in FIG. 1, it can be concluded that Test Group A has undergone hydration and that energy has been expended to repair the damaged dielectric. This is not the case for Test Group B where more of the phosphate remained in the oxide dielectric.

### EXAMPLE 4

An aqueous oxidizer solution containing approximately 40 wt % of ammonium persulfate was prepared. After preparation, the pH was measured and the solution divided into equal portions. The solutions were then doped to create the buffered and low pH conditions without producing polymer. Ammonium hydroxide was added to one portion to make Solution A with a pH of 4 and sulfuric acid was added to the other portion to make Solution B with a pH of 1. Aluminum anode coupons were immersed in the solutions for as little as 5 minutes and a long as 180 minutes. The oxide voltages were measured using an industry standard constant current technique to determine how the oxide degraded with respect to time. Anodes soaked in buffered Solution A showed little or no change in the oxide withstanding voltage indicating minimal oxide degradation. Anodes soaked in Solution B lost 1.6 volts. The results are presented in Table 3 and suggest that the low pH of Solution B degraded the oxide dielectric.

TABLE 3

| | Solution A Anodes | Solution B Anodes |
|---|---|---|
| Time (minutes) | Oxide Voltage @ pH = 4 | Oxide Voltage @ pH = 1 |
| 5 | 15.4 | 15.0 |
| 25 | 15.4 | 14.6 |
| 60 | 15.3 | 14.4 |
| 120 | 15.2 | 14.0 |
| 180 | 15.4 | 13.8 |

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. An oxidizer solution for preparing conductive polymers, the solution comprising:
at least one oxidizing agent; at least one buffering agent; and at least one solvent; wherein the pH of the oxidizer solution is from about 2 or greater.

2. The oxidizer solution of claim 1 comprising about 1 to about 40 wt % of the at least one oxidizing agent; and a sufficient amount of the at least one buffering agent to maintain the pH of the oxidizer solution greater than 2.

3. The oxidizer solution of claim 2 comprising about 25 to about 35 wt % of the at least one oxidizing agent.

4. The oxidizer solution of claim 1 wherein the pH is from about 2 to about 6.

5. The oxidizer solution of claim 4 wherein the pH is from about 2 to about 3.

6. The oxidizer solution of claim 1 wherein the solvent is water.

7. The oxidizer solution of claim 1 wherein the oxidizing agent is ammonium persulfate.

8. The oxidizer solution of claim 1 wherein the at least one buffering agent is ammonium hydroxide.

9. An aqueous oxidizer solution for preparing conductive polymers, the solution comprising about 1 to about 40 wt % ammonium persulfate; a sufficient amount of at least one ammonium hydroxide to maintain the pH of the oxidizer solution greater than 2; and water.

10. A process of preparing a conductive polymer layer on an anodized surface of an aluminum substrate comprising i) dipping the substrate in an oxidizer solution, ii) drying, and iii) dipping the substrate in a monomer solution and polymerizing;
wherein the oxidizer solution comprises at least one oxidizing agent; at least one buffering agent; and at least one solvent; wherein the pH of the oxidizer solution is from about 2 or greater and wherein additional buffering agent is added to the oxidizer solution at least once during the process of preparing the conductive polymer to maintain the pH at 2 or greater.

11. The process of claim 10 wherein additional buffering agent is added to the oxidizer solution at least twice during the process of preparing the conductive polymer to maintain the pH at 2 or greater.

12. The process of claim 11 wherein the buffering agent is added to the oxidizer solution 2 to 25 times during the process of preparing the conductive polymer to maintain the pH at 2 or greater.

13. The process of claim 10 wherein steps i) and ii) are repeated 1 to 5 times prior to step iii).

14. The process of claim 10 wherein ii) further comprises drying at a temperature of about 0 to about 150° C.

15. The process of claim 10 wherein the solvent comprises water.

16. The process of claim 10 further comprising, after dipping the substrate in a monomer solution and polymerizing, iv) washing the substrate in an aqueous solution.

17. The process of claim 10 wherein the oxidizer solution comprises about 1 to about 40 wt % of the at least one oxidizing agent; and a sufficient amount of the at least one buffering agent to maintain the pH of the oxidizer solution greater than 2.

18. The process of claim 17 wherein the oxidizer solution comprises about 25 to about 35 wt % of the at least one oxidizing agent.

19. The process of claim 10 wherein the pH of the oxidizer solution is from about 2 to about 6.

20. The process of claim 19 where the pH of the oxidizer solution is from about 2 to about 3.

21. The process of claim 10 wherein the at least one oxidizing agent is ammonium persulfate.

22. The process of claim 10 wherein the at least one buffering agent is ammonium hydroxide.

23. The process of claim 10 wherein the oxidizer solution comprises about 1 to about 40 wt % ammonium persulfate; a sufficient amount of at least one ammonium hydroxide to maintain the pH of the oxidizer solution greater than 2; and water.

24. A process of preparing a conductive polymer layer on an anodized surface of an aluminum substrate comprising i) dipping the substrate in an oxidizer solution, ii) drying, and iii) dipping the substrate in a monomer solution and polymerizing; wherein additional buffering agent is added to the oxidizer solution at least once during the process of preparing the conductive polymer to maintain the pH at 2 or greater.

25. The process of claim 24 wherein the buffering agent is added to the oxidizer solution 2 to 25 times during the process of preparing the conductive polymer to maintain the pH at 2 or greater.
